(19) United States
(12) Patent Application Publication
(10) Pub. No.: US 2026/0186272 A1
(43) Pub. Date: Jul. 2, 2026

(54) Camera Optical Lens

(71) Applicant: Changzhou AAC Raytech Optronics Co., Ltd., Changzhou City (CN)

(72) Inventor: Ronghui Cai, Changzhou (CN)

(21) Appl. No.: 19/294,222

(22) Filed: Aug. 7, 2025

Related U.S. Application Data
(63) Continuation of application No. PCT/CN2024/144472, filed on Dec. 31, 2024.

(51) Int. Cl. G02B 13/00

(52) U.S. Cl. CPC G02B 13/007; G02B 13/0015

(57) ABSTRACT

The present disclosure relates to a camera optical lens including, in an order from an object-side to an image-side in sequence: a first prism, a first lens, a second lens, a third lens, a fourth lens, and a fifth lens. The maximum focal length of the camera optical lens is fA, the back focal length is BF, the image height is IH, the distance on-axis from the most object-side lens surface to the most image-side lens surface at maximum focus is Lp, the total optical length is TTL, the curvature radius of the object-side and image-side surface of the first prism are Rp1 and Rp2 respectively. The curvature radius of the object-side and image-side surface of the fifth lens is R9 and R10 respectively. The camera optical lens satisfies: 6.00≤fA*BF/IH≤13.00; 0.40≤Lp/TTL≤0.51; −4.01≤Rp1/Rp2≤0.80; −0.80≤(R9+R10)/(R9−R10)≤0.30. The camera optical lens exhibits a long focal length, high magnification, and miniaturization.

### CROSS-REFERENCE TO RELATED APPLICATIONS

This application claims the priority benefit of PCT Patent Application Ser. No. PCT/CN2024/144472 filed on Dec. 31, 2024, the entire content of which is incorporated herein by reference.

### FIELD OF THE PRESENT DISCLOSURE

The present disclosure relates to optical lens, in particular to a camera optical lens.

### DESCRIPTION OF RELATED ART

In recent years, with the rise of smartphones, the demand for miniaturized camera lenses has progressively increased. Due to advancements in semiconductor manufacturing process technology, the pixel size of image sensors has been reduced. Combined with the trend of electronic products toward high functionality and slim, compact form factors, miniaturized camera lenses possessing superior imaging quality have consequently become the mainstream in the current market.

With the advancement of technology and the increasing diversity of user demands, under the circumstances of continuous reduction in pixel area of image sensors and escalating requirements for imaging quality, three-element, four-element, and even five-element lens structures have gradually emerged in optical designs. However, as technology evolves and user requirements further diversify, amid the ongoing shrinkage of pixel area and heightened demands for imaging performance, six-element lens structures are being increasingly adopted. Although conventional six-element designs exhibit improved optical performance, their suboptimal distribution of optical power, lens spacing, and lens curvature configurations still exhibit certain irrationalities. Consequently, while achieving satisfactory optical performance, such lens structures fail to simultaneously meet the design requirements of long focal length, high magnification, and compact form factors.

### SUMMARY

It is an object of the present disclosure to provide a camera optical lens that achieves high imaging performance while simultaneously meeting the requirements of long focal length, high magnification, and miniaturization.

In order to overcome shortcomings in the prior art, the present disclosure provides a camera optical lens including, in an order from an object side to an image side in sequence: a first prism with a positive refractive power, a first lens with a negative refractive power, a second lens with a positive refractive power, a third lens with a negative refractive power, a fourth lens with a positive refractive power, a fifth lens with a negative refractive power; wherein a reflective surface is disposed between the object side surface and image side surface of the first prism, the first lens, the second lens, the third lens, the fourth lens, and the fifth lens form a lens assembly, the lens assembly is adjustably movable along the optical axis of the camera optical lens to switch between a first state and a second state, the camera optical lens achieves its maximum focal length in the first state, and achieves its minimum focal length in the second state, the camera optical lens further satisfies the following conditions:

$$\begin{matrix}6. \leq fA * BF / IH \leq 13. ; \\ 0.4 \leq Lp / TTL \leq 0.51 ; \\ - 4.01 \leq Rp 1 / Rp 2 \leq - 0.8 ; \\ - 0.8 \leq ( R 9 + R 10 ) / ( R 9 - R 10 ) \leq - 0 \text{.30} ;\end{matrix}$$

where
fA: the focal length of the camera optical lens in the first state;
BF: the back focal length of the camera optical lens;
IH: the image height of the camera optical lens;
Lp: the distance on-axis from the most object-side lens surface to the most image-side lens surface in the first state;
Rp1: the curvature radius of the object side surface of the first prism;
Rp2: the curvature radius of the image side surface of the first prism;
R9: the curvature radius of the object side surface of the fifth lens;
R10: the curvature radius of the image side surface of the fifth lens;
TTL: the total optical length of the camera optical lens.

As an improvement, the camera optical lens further satisfies the following condition:

$$3. \leq ( f 4 - f 5 ) / f 2 \leq 4.5 ;$$

where
f2: the focal length of the second lens;
f4: the focal length of the fourth lens;
f5: the focal length of the fifth lens.

As an improvement, an object side surface of the first prism is convex in the paraxial region, an image side surface of the first prism is convex in the paraxial region, and the camera optical lens further satisfies the following conditions:

$$\begin{matrix}0.69 \leq fp 1 / fA \leq 0.85 ; \\ 0.375 \leq dp 1 / TTL \leq 0.414 ;\end{matrix}$$

where
fp1: the focal length of the first prism;
dp1: the sum of the distance on-axis from the object side surface of the first prism to the reflective surface, and the distance on-axis from the reflective surface to the image side surface of the first prism.

As an improvement, an object side surface of the first lens is convex in the paraxial region, an image side surface of the first lens is concave in the paraxial region, and the camera optical lens further satisfies the following conditions:

$$\begin{matrix}- 0.6 \; 4 \leq f 1 / fA \leq - 0 \text{.54} ; \\ 1.03 \leq ( R 1 + R 2 ) / ( R 1 - R 2 ) \leq 1.13 ; \\ 0.031 \leq d 1 / TTL \leq 0.06 ;\end{matrix}$$

where
f1: the focal length of the first lens;
R1: the curvature radius of the object side surface of the first lens;
R2: the curvature radius of the image side surface of the first lens;
d1: the thickness on-axis of the first lens.

As an improvement, an object side surface of the second lens is convex in the paraxial region, an image side surface of the second lens is convex in the paraxial region, and the camera optical lens further satisfies the following conditions:

$$\begin{matrix}0.47 \leq f2 / fA \leq 0.58 ; \\ - 0.6 \; 3 \leq ( R 3 + R 4 ) / ( R 3 - R 4 ) \leq - 0 \text{.22} ; \\ 0.063 \leq d 3 / TTL \leq 0.089 ;\end{matrix}$$

where
f2: the focal length of the second lens;
R3: the curvature radius of the object side surface of the second lens;
R4: the curvature radius of the image side surface of the second lens;
d3: the thickness on-axis of the second lens.

As an improvement, an object side surface of the third lens is convex in the paraxial region, an image side surface of the third lens is concave in the paraxial region, and the camera optical lens further satisfies the following conditions:

$$\begin{matrix}- 1.19 \leq f 3 / fA \leq - 0.61 ; \\ 1.6 \leq ( R 5 + R 6 ) / ( R 5 - R 6 ) \leq 2.41 ; \\ 0.066 \leq d 5 / TTL \leq 0.088 ;\end{matrix}$$

where
f3: the focal length of the third lens;
R5: the curvature radius of the object side surface of the third lens;
R6: the curvature radius of the image side surface of the third lens;
d5: the thickness on-axis of the third lens.

As an improvement, an object side surface of the fourth lens is concave in the paraxial region, an image side surface of the fourth lens is convex in the paraxial region, and the camera optical lens further satisfies the following conditions:

$$\begin{matrix}0.81 \leq f 4 / fA \leq 1.37 ; \\ 2.88 \leq ( R 7 + R 8 ) / ( R 7 - R 8 ) \leq 7.62 ; \\ 0.043 \leq d 7 / TTL \leq 0.048 ;\end{matrix}$$

where
f4: the focal length of the fourth lens;
R7: the curvature radius of the object side surface of the fourth lens;
R8: the curvature radius of the image side surface of the fourth lens;
d7: the thickness on-axis of the fourth lens.

As an improvement, an object side surface of the fifth lens is concave in the paraxial region, an image side surface of the fifth lens is concave in the paraxial region, and the camera optical lens further satisfies the following conditions:

$$\begin{matrix}- 1.28 \leq f 5 / fA \leq - 0.64 ; \\ 0.063 \leq d 9 / TTL \leq 0.073 ;\end{matrix}$$

where
f5: the focal length of the fifth lens;
d9: the thickness on-axis of the fifth lens.

As an improvement, the first prism is made of glass material.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a schematic diagram of a camera optical lens 10 in accordance with a first embodiment of the present disclosure in a first state;

FIG. 2 shows the lateral color of the camera optical lens 10 shown in FIG. 1;

FIG. 3 shows the longitudinal aberration of the camera optical lens 10 shown in FIG. 1;

FIG. 4 presents a schematic diagram of the field curvature and distortion of the camera optical lens 10 shown in FIG. 1;

FIG. 5 is a schematic diagram of a camera optical lens 20 in accordance with a second embodiment of the present disclosure in a first state;

FIG. 6 shows the lateral color of the camera optical lens 20 shown in FIG. 5;

FIG. 7 shows the longitudinal aberration of the camera optical lens 20 shown in FIG. 5;

FIG. 8 presents a schematic diagram of the field curvature and distortion of the camera optical lens 20 shown in FIG. 5;

FIG. 9 is a schematic diagram of a camera optical lens 30 in accordance with a third embodiment of the present disclosure in a first state;

FIG. 10 shows the lateral color of the camera optical lens 30 shown in FIG. 9;

FIG. 11 shows the longitudinal aberration of the camera optical lens 30 shown in FIG. 9;

FIG. 12 presents a schematic diagram of the field curvature and distortion of the camera optical lens 30 shown in FIG. 9;

FIG. 13 is a schematic diagram of a camera optical lens 40 in accordance with a fourth embodiment of the present disclosure in a first state;

FIG. 14 shows the lateral color of the camera optical lens 40 shown in FIG. 13;

FIG. 15 shows the longitudinal aberration of the camera optical lens 40 shown in FIG. 13;

FIG. 16 presents a schematic diagram of the field curvature and distortion of the camera optical lens 40 shown in FIG. 13;

FIG. 17 is a schematic diagram of a camera optical lens 50 in accordance with a fifth embodiment of the present disclosure in a first state;

FIG. 18 shows the lateral color of the camera optical lens 50 shown in FIG. 17;

FIG. 19 shows the longitudinal aberration of the camera optical lens 50 shown in FIG. 17;

FIG. 20 presents a schematic diagram of the field curvature and distortion of the camera optical lens 50 shown in FIG. 17;

FIG. 21 is a schematic diagram of a camera optical lens 60 in accordance with a sixth embodiment of the present disclosure in a first state;

FIG. 22 shows the lateral color of the camera optical lens 60 shown in FIG. 21;

FIG. 23 shows the longitudinal aberration of the camera optical lens 60 shown in FIG. 21;

FIG. 24 presents a schematic diagram of the field curvature and distortion of the camera optical lens 60 shown in FIG. 21.

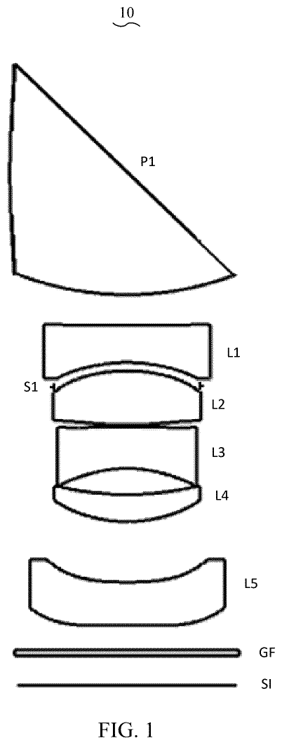

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

The present disclosure provides camera optical lenses 10-50. The camera optical lenses 10-50 includes, sequentially arranged from the object side to the image side: a first prism P1 having a positive refractive power, a first lens L1 having a negative refractive power, a second lens L2 having a positive refractive power, a third lens L3 having a negative refractive power, a fourth lens L4 having a positive refractive power, and a fifth lens L5 having a negative refractive power. A reflective surface is provided between the object side surface and the image side surface of the first prism P1.

The first lens L1, the second lens L2, the third lens L3, the fourth lens L4, and the fifth lens L5 form a lens assembly, the lens assembly is adjustably movable along the optical axis of the camera optical lenses 10-50, enabling the camera optical lenses 10-50 to switch between a first state and a second state. The camera optical lenses 10-50 achieve their maximum focal length in the first state, and achieve their minimum focal length in the second state.

The lens assembly is positioned between the first prism P1 and the image plane SI, and the lens assembly is adjustably movable along the optical axis of the camera optical lenses 10-50, such that both the distance on-axis from the image-side surface of the first prism P1 to the object side surface of the lens assembly and the distance on-axis from the image side surface of the lens assembly to the image plane SI are adjustable. Thereby, the lens assembly functions as a movable zoom group. By displacing this lens assembly, the focal length of the camera optical lens 10-50 can be varied, enabling optimized imaging performance in both a first state and a second state. The first state refers to a state in which the camera optical lenses 10-50 have a maximum focal length, and the second state refers to a state in which the camera optical lenses 10-50 have a minimum focal length. For example, the first state may be a telephoto state or an infinite-object-distance state; the second state may be a short-focus state or a macro state. Thereby, the camera optical lenses 10-50 achieve an internal focusing (IF) mode by displacing the lens group along the optical axis.

The focal length of the camera optical lenses 10-50 in the first state is defined as fA, the back focal length of the camera optical lenses 10-50 is defined as BF, and the image height of the camera optical lenses 10-50 is defined as IH. The following conditional expression is satisfied: 6.00≤fA*BF/IH≤13.00. This specifies the ratio of the product of the focal length and back focus to the image height. An optical system satisfying this condition achieves a longer focal length at a fixed image height, thereby enhancing the system magnification.

The distance on-axis from the most object-side lens surface to the most image-side lens surface of the camera optical lenses 10-50 in the first state is defined as Lp, and the total optical length of the camera optical lenses 10-50 is defined as TTL. The following conditional expression is satisfied: 0.40≤Lp/TTL≤0.51. This specifies the ratio of the lens assembly length to the total track length. Maintaining this ratio within the prescribed range facilitates compression of the optical total length of the camera optical lens 10-50.

The curvature radius of the object side surface of the first prism P1 is defined as Rp1, and the curvature radius of the image side surface of the first prism P1 is defined as Rp2. The following conditional expression is satisfied: −4.01≤Rp1/Rp2≤−0.80. This specifies the surface curvature configuration of the first prism P1. Maintaining this configuration within the prescribed range mitigates ray deflection angles, thereby effectively suppressing aberrations.

The curvature radius of the object side surface of the fifth lens L5 is defined as R9, and the curvature radius of the image side surface of the fifth lens L5 is defined as R10. The following conditional expression is satisfied: −0.80≤(R9+R10)/(R9−R10)≤−0.30. This specifies the shape of the fifth lens L5. Maintaining this shape within the prescribed range mitigates ray deflection angles, thereby effectively suppressing aberrations.

When the focal length, image height, total optical length, focal lengths of individual lenses, thicknesses on-axis, and curvature radius of individual lenses of the camera optical lenses 10-50 satisfy the aforementioned relational expressions, the design requirements for long focal length, high magnification ratio, and compactness are fulfilled.

Based on the aforementioned conditional expressions and achievable functionalities, the characteristics of each lens are further refined as follows.

The focal length of the second lens L2, the fourth lens L4 and the fifth lens L5 are defined as f2, f4 and f5, respectively. The following conditional expression is satisfied: 3.00≤(f4−f5)/f2≤4.50. This specifies the focal power relationships of the lens assembly in the camera optical lens. By rationally distributing the focal power of each lens, the optical system achieves improved imaging quality and reduced sensitivity to assembly tolerances.

In the present disclosure, the object side surface of the first prism P1 is convex in the paraxial region, and the image side surface of the first prism P1 is convex in the paraxial region. Alternatively, the object side and image side surfaces of the first prism P1 may employ other surface configurations.

The focal length of the first prism P1 is defined as fp1, and the following conditional expression is satisfied: 0.69≤fp1/fA≤0.85. This specifies a positive refractive power for the first prism P1. Maintaining this parameter within the prescribed numerical range facilitates reduction of aberrations and enhancement of the imaging quality of the camera optical lenses 10-50.

The sum of the distance on-axis from the object side surface of the first prism P1 to the reflective surface, and the distance on-axis from the reflective surface to the image side surface of the first prism P1 is defined as dp1, and the following conditional expression is satisfied: 0.375≤dp1/TTL≤0.414. This configuration enables rational control of the optical total length of the camera optical lens.

In the present disclosure, the object side surface of the first lens L1 is convex in the paraxial region, and the image side surface of the first lens L1 is concave in the paraxial region. Alternatively, the object side and image side surfaces of the first lens L1 may employ other concave-convex configurations.

The focal length of the first lens L1 is defined as f1, and the following conditional expression is satisfied: −0.64≤f1/fA≤−0.54. By controlling the negative refractive power of the first lens L1 within a reasonable range, aberrations of the optical system can be effectively corrected.

The curvature radius of the object side surface of the first lens L1 is defined as R1, and the curvature radius of the image side surface of the first lens L1 is defined as R2. The following conditional expression is satisfied: 1.03≤(R1+R2)/(R1−R2)≤1.13. The shape of the first lens L1 is defined such that, within the specified range, it facilitates compensation of axial chromatic aberration while advancing lens miniaturization.

The thickness on-axis of the first lens L1 is defined as d1, and the following conditional expression is satisfied: 0.031≤d1/TTL≤0.060, thereby facilitating realization of ultra-thin design.

In the present disclosure, the object side surface of the second lens L2 is convex in the paraxial region, and the image side surface of the second lens L2 is convex in the paraxial region. Alternatively, the object side and image side surfaces of the second lens L2 may employ other concave-convex configurations.

The focal length of the second lens L2 is defined as f2, and the following conditional expression is satisfied: 0.47≤f2/fA≤0.58. Through rational allocation of refractive power, the system achieves enhanced imaging quality and reduced sensitivity.

The curvature radius of the object side surface of the second lens L2 is defined as R3, the curvature radius of the image side surface of the second lens L2 is defined as R4. The following conditional expression is satisfied: −0.63≤(R3+R4)/(R3−R4)≤−0.22. This enables precise control of the shape of the second lens L2, facilitating its molding process while preventing defects and stress generation due to excessive surface curvature.

The thickness on-axis of the second lens L2 is defined as d3, and the following conditional expression is satisfied: 0.063≤d3/TTL≤0.089, thereby facilitates rational control of the total optical length of the camera optical lens.

In the present disclosure, the object side surface of the third lens L3 is convex in the paraxial region, and the image side surface of the third lens L3 is concave in the paraxial region. Alternatively, the object side and image side surfaces of the third lens L3 may employ other concave-convex configurations.

The focal length of the third lens L3 is defined as f3, and the following conditional expression is satisfied: −1.19≤f3/fA≤−0.61. Through rational allocation of refractive power, the system achieves enhanced imaging quality and reduced sensitivity.

The curvature radius of the object side surface of the third lens L3 is defined as R5, and the curvature radius of the image side surface of the third lens L3 is defined as R6. The following conditional expression is satisfied: 1.60≤(R5+R6)/(R5−R6)≤2.41. This configuration defines the shape of the third lens L3, which facilitates correction of off-axis aberrations during miniaturization advancement when within the specified range.

The thickness on-axis of the third lens L3 is defined as d5, and the following conditional expression is satisfied: 0.066≤d5/TTL≤0.088. This configuration defines the ratio of the thickness on-axis of the third lens L3 to the total optical length of the camera optical lenses 10-50, facilitating rational control of the total optical length of the camera optical lens.

In the present disclosure, the object side surface of the fourth lens L4 is concave in the paraxial region, and the image side surface of the fourth lens L4 is convex in the paraxial region. Alternatively, the object side and image side surfaces of the fourth lens L4 may employ other concave-convex configurations.

The focal length of the fourth lens L4 is defined as f4, and the following conditional expression is satisfied: 0.81≤f4/fA≤1.37. This constraint to the fourth lens L4 effectively flattens the ray angle in the camera lens, reducing tolerance sensitivity.

The curvature radius of the object side surface of the fourth lens L4 is defined as R7, and the curvature radius of the image side surface of the fourth lens L4 is defined as R8. The following conditional expression is satisfied: 2.88≤(R7+R8)/(R7−R8)≤7.62. This configuration defines the shape of the fourth lens L4 and facilitates correction of off-axis aberrations during miniaturization.

The thickness on-axis of the fourth lens L4 is defined as d7, and the following conditional expression is satisfied: 0.043≤d7/TTL≤0.048, thereby rationally controlling the total track length of the camera optical lens.

In the present disclosure, the object side surface of the fifth lens is concave in the paraxial region, an image side surface of the fifth lens is concave in the paraxial region. Alternatively, the object side and image side surfaces of the fifth lens L5 may employ other concave-convex configurations.

The focal length of the fifth lens L5 is defined as f5, and the following conditional expression is satisfied: −1.28≤f5/fA≤−0.64. This constraint to the fifth lens L5 effectively flattens the ray angle in the camera lens and reduces tolerance sensitivity.

The thickness on-axis of the fifth lens L5 is defined as d9, and the following conditional expression is satisfied: 0.063≤d9/TTL≤0.073, thereby rationally controlling the total track length of the camera optical lens.

In the present disclosure, the first prism P1 is made of glass; the first lens L1, the second lens L2, the third lens L3, the fourth lens L4, and the fifth lens L5 are all made of plastic. In other optional embodiments, the first prism P1 and the lenses may employ alternative materials.

Between the fifth lens L5 and the image plane SI, an optical filter GF may be disposed—which may be a glass cover plate or an optical filter (e.g., spectral filter).

An aperture stop S1 is further disposed between the first lens L1 and the second lens L2, though it may alternatively be positioned elsewhere.

Specific implementable embodiments are detailed below.

The camera optical lenses of the present disclosure will be described below with reference to various embodiments. The symbols used in each embodiment are as follows. The focal length, the distance on-axis, the curvature radius, and the thickness on-axis are expressed in millimeters.

TTL: Total optical length (the distance on-axis from the object side surface of the first prism P1 to the image plane SI), expressed in millimeters.

BF: Back focal length (the distance on-axis from the image side surface of the fifth lens L5 to the image plane SI), expressed in millimeters.

The technical solutions of the present disclosure will be specifically described through six embodiments.

### Embodiment 1

The first prism P1 has positive refractive power, with its object side surface convex in the paraxial region and its image side surface convex in the paraxial region;
The first lens L1 has negative refractive power, with its object side surface convex in the paraxial region and its image side surface concave in the paraxial region;
The second lens L2 has positive refractive power, with its object side surface convex in the paraxial region and its image side surface convex in the paraxial region;
The third lens L3 has negative refractive power, with its object side surface convex in the paraxial region and its image side surface concave in the paraxial region;
The fourth lens L4 has positive refractive power, with its object side surface concave in the paraxial region and its image side surface convex in the paraxial region;
The fifth lens L5 has negative refractive power, with its object side surface concave in the paraxial region and its image side surface concave in the paraxial region.

Table 1 presents the c for Embodiment 1 of the camera optical lens 10 in the present disclosure, in which, d1=“dp1-01”+“dp1-02”, “dp1-01”=4.260 mm, and “dp1-02”=4.440 mm.

TABLE 1
Design data of the camera optical lens 10

| | R | d | | nd | | vd | |
|---|---|---|---|---|---|---|---|
| S1 | ∞ | d0= | −11.522 | | | | |
| Rp1 | 34.119 | dp1= | 8.700 | nd1 | 1.8052 | vd1 | 40.91 |
| Rp2 | −10.498 | dp2= | dp2 | | | | |
| R1 | 83.348 | d1= | 1.370 | nd2 | 1.6400 | vd2 | 23.54 |
| R2 | 5.027 | d2= | 0.311 | | | | |
| R3 | 5.322 | d3= | 2.000 | nd3 | 1.544 | vd3 | 55.82 |
| R4 | −13.710 | d4= | 0.068 | | | | |
| R5 | 17.106 | d5= | 1.540 | nd4 | 1.6153 | vd4 | 25.94 |
| R6 | 4.177 | d6= | 0.975 | | | | |
| R7 | −8.278 | d7= | 1.000 | nd5 | 1.6700 | vd5 | 19.39 |
| R8 | −4.583 | d8= | 2.242 | | | | |
| R9 | −11.776 | d9= | 1.600 | nd6 | 1.5346 | vd6 | 55.69 |
| R10 | 47.106 | d10= | d10 | | | | |
| R11 | ∞ | d11= | 0.210 | ndg | 1.5168 | vdg | 64.17 |
| R12 | ∞ | d12= | 1.097 | | | | |

Table 2 presents the data of relevant optical parameters for the camera optical lens 10 according to the first embodiment of the present disclosure in both the first state (infinity focus state) and the second state (macro focus state).

TABLE 2
Relevant Optical Parameters of Camera Optical
Lens 10 in Different Focus States

| | First state | Second state |
|---|---|---|
| f | 14.500 | 13.586 |
| FOV | 27.33° | 26.30° |
| FNO | 1.98 | 1.86 |
| dp2 | 1.140 | 1.958 |
| d10 | 0.899 | 0.081 |

In which, the meaning of the various symbols is as follows.
S1: Aperture;
R: The curvature radius of the optical surface, the central curvature radius in case of lens;
Rp1: The curvature radius of the object side surface of the first prism P1;
Rp2: The curvature radius of the image side surface of the first prism P1;
R1: The curvature radius of the object side surface of the first lens L1;
R2: The curvature radius of the image side surface of the first lens L1;
R3: The curvature radius of the object side surface of the second lens L2;
R4: The curvature radius of the image side surface of the second lens L2;
R5: The curvature radius of the object side surface of the third lens L3;
R6: The curvature radius of the image side surface of the third lens L3;
R7: The curvature radius of the object side surface of the fourth lens L4;
R8: The curvature radius of the image side surface of the fourth lens L4;
R9: The curvature radius of the object side surface of the fifth lens L5;
R10: The curvature radius of the image side surface of the fifth lens L5;
R11: The curvature radius of the object side surface of the optical filter GF;
R12: The curvature radius of the image side surface of the optical filter GF;
d: The thickness on-axis of the lens and the distance on-axis between the lens;
d0: The distance on-axis from aperture S1 to the object side surface of the first prism P1;
dp1: The sum of the distance on-axis from the object side surface of the first prism P1 to the reflective surface, and the distance on-axis from the reflective surface to the image side surface of the first prism P1;
dp1-01: The distance on-axis from the object side surface of the first prism P1 to the reflective surface;
dp2-02: The distance on-axis from the reflective surface to the image side surface of the first prism P1;
dp2: The distance on-axis from the image side surface of the first prism P1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 to the object side surface of the third lens L3;
d5: The thickness on-axis of the third lens L3;
d6: The distance on-axis from the image side surface of the third lens L3 to the object side surface of the fourth lens L4;
d7: The thickness on-axis of the fourth lens L4;
d8: The distance on-axis from the image side surface of the fourth lens L4 to the object side surface of the fifth lens L5;
d9: The thickness on-axis of the fifth lens L5;
d10: The distance on-axis from the image side surface of the fifth lens L5 to the object side surface of the optical filter GF;
d11: The thickness on-axis of the optical filter GF;
d12: The distance on-axis from the image side surface of the optical filter GF to the image plane SI;
nd: The refractive power of the d line;
nd1: The refractive power of the d line of the first prism P1;
nd2: The refractive power of the d line of the first lens L1;
nd3: The refractive power of the d line of the second lens L2;
nd4: The refractive power of the d line of the third lens L3;
nd5: The refractive power of the d line of the fourth lens L4;
nd6: The refractive power of the d line of the fifth lens L5;
ndg: The refractive power of the d line of the optical filter GF;
vd: The abbe number;
v1: The abbe number of the first prism P1;
v2: The abbe number of the first lens L1;
v3: The abbe number of the second lens L2;
v4: The abbe number of the third lens L3;
v5: The abbe number of the fourth lens L4;
V6: The abbe number of the fifth lens L5;
vg: The abbe number of the optical filter GF.

Table 3 shows the aspherical surface data of each lens in the camera optical lens 10 in the embodiment 1 of the present disclosure.

TABLE 3
Aspherical surface data of the camera optical lens 10

| | Conic Index | Aspherical Surface Index | | | |
|---|---|---|---|---|---|
| | k | A4 | A6 | A8 | A10 |
| Rp1 | −4.01287E+01 | −1.06200E−04 | −5.12500E−06 | −1.98600E−07 | 1.90540E−08 |
| Rp2 | 0.00000E+00 | 0.00000E+00 | 0.00000E+00 | 0.00000E+00 | 0.00000E+00 |
| R1 | 1.79553E+01 | −3.71030E−03 | 3.90460E−04 | −2.87040E−06 | −8.97560E−06 |
| R2 | −3.69557E−02 | −8.36190E−03 | 1.60420E−03 | −1.90870E−04 | 3.50140E−05 |
| R3 | −1.25525E+01 | 7.58160E−03 | −6.63230E−04 | 2.56020E−04 | −4.09120E−05 |
| R4 | −4.82237E+01 | −1.00900E−02 | 6.78440E−03 | −2.14980E−03 | 4.11640E−04 |
| R5 | −1.01006E+01 | −1.35530E−02 | 5.99710E−03 | −1.87950E−03 | 3.54020E−04 |
| R6 | −1.64158E+01 | 2.35240E−02 | −1.13050E−02 | 5.02540E−03 | −1.77860E−03 |
| R7 | −9.79377E−01 | 7.43410E−03 | −2.51410E−03 | 9.15530E−04 | −3.35120E−04 |
| R8 | −1.42807E+01 | −1.41840E−02 | 3.80760E−03 | −1.32260E−03 | 3.67370E−04 |
| R9 | −3.58702E+00 | −3.95000E−03 | −2.54980E−03 | 1.32470E−03 | −4.79400E−04 |
| R10 | 1.66536E+02 | −3.46790E−03 | −1.98640E−03 | 8.93080E−04 | −2.39750E−04 |
| | Conic Index | Aspherical Surface Index | | | |
| | k | A12 | A14 | A16 | A18 |
| Rp1 | −4.01287E+01 | −1.03190E−09 | −4.64580E−11 | 8.01960E−12 | −3.31610E−13 |
| Rp2 | 0.00000E+00 | 0.00000E+00 | 0.00000E+00 | 0.00000E+00 | 0.00000E+00 |
| R1 | 1.79553E+01 | 2.86630E−06 | −4.87500E−07 | 4.66540E−08 | −2.40270E−09 |
| R2 | −3.69557E−02 | −3.08740E−06 | −1.05190E−07 | 2.59120E−08 | −8.83210E−10 |
| R3 | −1.25525E+01 | 5.48070E−06 | −6.76190E−07 | 5.34740E−08 | −1.83610E−09 |
| R4 | −4.82237E+01 | −4.84000E−05 | 3.52190E−06 | −1.46320E−07 | 2.11770E−09 |
| R5 | −1.01006E+01 | −3.96060E−05 | 2.45750E−06 | −6.68290E−08 | −7.51320E−10 |
| R6 | −1.64158E+01 | 4.63750E−04 | −8.50180E−05 | 1.04130E−05 | −7.65730E−07 |
| R7 | −9.79377E−01 | 9.52800E−05 | −2.04250E−05 | 2.94780E−06 | −2.40840E−07 |
| R8 | −1.42807E+01 | −7.59100E−05 | 1.04750E−05 | −9.02480E−07 | 4.58480E−08 |
| R9 | −3.58702E+00 | 1.13540E−04 | −1.75930E−05 | 1.73320E−06 | −9.88430E−08 |
| R10 | 1.66536E+02 | 4.03080E−05 | −4.30350E−06 | 2.84350E−07 | −1.06270E−08 |

| | Conic Index | Aspherical Surface Index |
|---|---|---|
| | k | A20 |
| Rp1 | −4.01287E+01 | 4.35210E−15 |
| Rp2 | 0.00000E+00 | 0.00000E+00 |
| R1 | 1.79553E+01 | 5.29190E−11 |
| R2 | −3.69557E−02 | 1.01690E−13 |
| R3 | −1.25525E+01 | 1.32960E−12 |
| R4 | −4.82237E+01 | 1.20760E−13 |
| R5 | −1.01006E+01 | 6.76000E−11 |
| RE | −1.64158E+01 | 2.57070E−08 |
| R7 | −9.79377E−01 | 8.26480E−09 |
| R8 | −1.42807E+01 | −1.13760E−09 |
| R9 | −3.58702E+00 | 2.50340E−09 |
| R10 | 1.66536E+02 | 1.71980E−10 |

For convenience, the aspheric surface of each lens surface uses the aspheric surfaces shown in the following condition (1). However, the present disclosure is not limited to the aspherical polynomials form shown in the condition (1).

$$\begin{matrix}z = ( {cr}^{2} ) / \{ 1 + [ 1 - \\ {( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 \\ {r}^{18} + A 20 {r}^{20}\end{matrix} \qquad ( 1 )$$

Among them, K is a conic index, A4, A6, A8, A10, A12, A14, A16, A18, A20 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

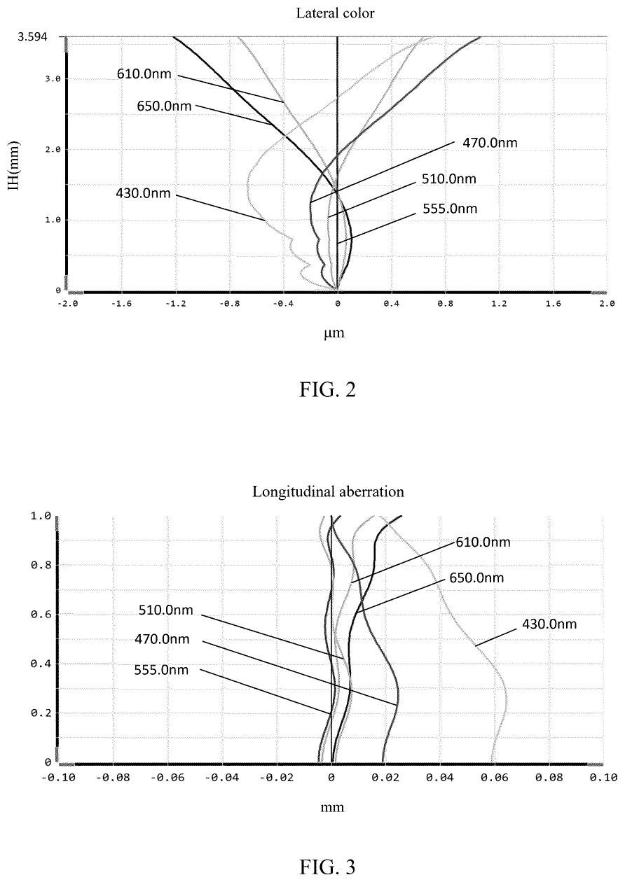

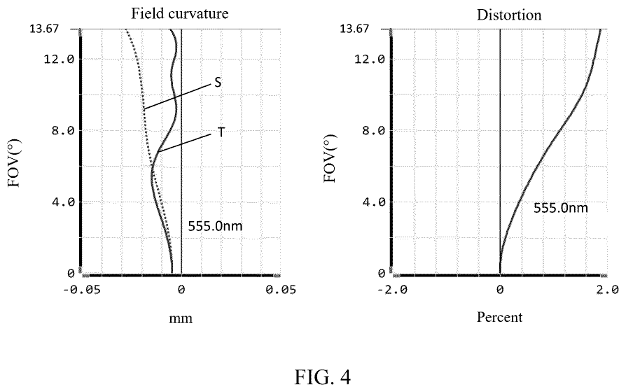

FIG. 2 and FIG. 3 show the lateral color and longitudinal aberration schematic diagrams after light with a wavelength of 650 nm, 610 nm, 555 nm, 510 nm, 470 nm and 430 nm passes the camera optical lens 10 in the first embodiment. FIG. 4 shows the field curvature and distortion schematic diagrams after light with a wavelength of 555 nm passes the camera optical lens 10 in the first embodiment, the field curvature S in FIG. 4 is a field curvature in the sagittal direction, T is a field curvature in the meridian direction.

Subsequent Table 19 lists the values corresponding to specified parameters in the conditional expressions for each of Embodiments 1, 2, 3, 4, 5, and 6.

As shown in Table 19, the first embodiment satisfies all conditional expressions.

In this embodiment, the pupil entering diameter (ENPD) of the camera optical lens 10 is 7.311 mm, the full-field image height (IH) is 3.594 mm, and the diagonal field of view (FOV) is 27.33°. This design satisfies the requirements of long focal length, high magnification, and miniaturization, while exhibiting excellent optical characteristics.

### Embodiment 2

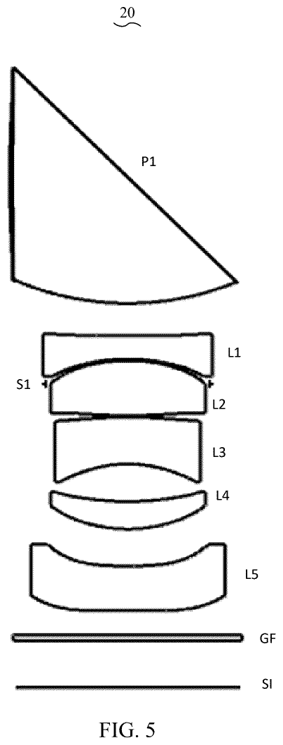

Embodiment 2 is basically the same as embodiment 1, the meaning of its symbols is the same as that of embodiment 1, the structural configuration of the camera optical lens 20 according to the second embodiment is illustrated in FIG. 5, and in the following, only the differences are described.

Table 4 present the design data of the camera optical lens 20 according to the second embodiment of the present disclosure, in which, d1=“dp1-01”+“dp1-02”, “dp1-01”=4.130 mm, and “dp1-02”=4.570 mm.

TABLE 4
Design data of the camera optical lens 20

| | R | d | | nd | | vd | |
|---|---|---|---|---|---|---|---|
| S1 | ∞ | d0= | −10.774 | | | | |
| Rp1 | 38.650 | dp1= | 8.700 | nd1 | 1.8052 | vd1 | 40.91 |
| Rp2 | −9.662 | dp2= | dp2 | | | | |
| R1 | 194.836 | d1= | 0.845 | nd2 | 1.6400 | vd2 | 23.54 |
| R2 | 5.403 | d2= | 0.057 | | | | |
| R3 | 5.372 | d3= | 2.000 | nd3 | 1.5444 | vd3 | 55.82 |
| R4 | −23.625 | d4= | 0.056 | | | | |
| R5 | 11.278 | d5= | 1.698 | nd4 | 1.6153 | vd4 | 25.94 |
| R6 | 4.033 | d6= | 1.366 | | | | |
| R7 | −8.208 | d7= | 1.000 | nd5 | 1.6700 | vd5 | 19.39 |
| R8 | −4.654 | d8= | 1.347 | | | | |
| R9 | −13.744 | d9= | 1.600 | nd6 | 1.5346 | vd6 | 55.69 |
| R10 | 32.069 | d10= | d10 | | | | |
| R11 | ∞ | d11= | 0.210 | ndg | 1.5168 | vdg | 64.17 |
| R12 | ∞ | d12= | 1.716 | | | | |

Table 5 presents the data of relevant optical parameters for the camera optical lens 20 according to the second embodiment of the present disclosure in both the first state (infinity focus state) and the second state (macro focus state).

TABLE 5
Relevant Optical Parameters of Camera Optical
Lens 20 in Different Focus States

| | First state | Second state |
|---|---|---|
| f | 14.376 | 13.423 |
| FOV | 27.67° | 26.91° |
| FNO | 1.98 | 1.85 |
| dp2 | 1.173 | 1.970 |
| d10 | 0.888 | 0.091 |

Table 6 shows the aspherical surface data of the camera optical lens 20 in the embodiment 2 of the present disclosure.

TABLE 6
Aspherical surface data of the camera optical lens 20

| | Conic Index | Aspherical Surface Index | | | |
|---|---|---|---|---|---|
| | k | A4 | A6 | A8 | A10 |
| Rp1 | −7.28771E+01 | −1.63080E−04 | −7.34490E−06 | −1.82280E−07 | 1.91110E−08 |
| Rp2 | 0.00000E+00 | 0.00000E+00 | 0.00000E+00 | 0.00000E+00 | 0.00000E+00 |
| R1 | 9.99000E+02 | −3.63420E−03 | 4.00880E−04 | −2.90590E−06 | −9.05130E−06 |
| R2 | 1.01496E−01 | −8.13800E−03 | 1.60280E−03 | −1.93080E−04 | 3.48780E−05 |
| R3 | −1.32923E+01 | 7.18670E−03 | −6.76020E−04 | 2.55900E−04 | −4.10280E−05 |
| R4 | −7.36679E+01 | −1.01500E−02 | 6.75340E−03 | −2.14880E−03 | 4.11740E−04 |
| R5 | −2.60601E+00 | −1.32440E−02 | 6.05110E−03 | −1.87550E−03 | 3.54270E−04 |
| R6 | −1.54843E+01 | 2.51570E−02 | −1.20080E−02 | 5.52700E−03 | −2.08270E−03 |
| R7 | −7.30030E−01 | 7.37610E−03 | −2.51680E−03 | 9.10190E−04 | −3.35090E−04 |
| R8 | −1.51169E+01 | −1.26240E−02 | 2.93550E−03 | −8.13000E−04 | 1.30620E−04 |
| R9 | −4.65434E−01 | −3.87600E−03 | −2.79190E−03 | 1.31700E−03 | −4.79080E−04 |
| R10 | 7.40553E+01 | −4.97310E−03 | −1.40540E−03 | 6.85120E−04 | −1.95620E−04 |
| | Conic Index | Aspherical Surface Index | | | |
| | k | A12 | A14 | A16 | A18 |
| Rp1 | −7.28771E+01 | −1.12010E−09 | −5.06570E−11 | 8.24260E−12 | −3.20080E−13 |
| Rp2 | 0.00000E+00 | 0.00000E+00 | 0.00000E+00 | 0.00000E+00 | 0.00000E+00 |
| R1 | 9.99000E+02 | 2.86000E−06 | −4.87210E−07 | 4.66960E−08 | −2.40270E−09 |
| R2 | 1.01496E−01 | −3.07140E−06 | −1.05510E−07 | 2.59120E−08 | −8.83210E−10 |
| R3 | −1.32923E+01 | 5.45270E−06 | −6.85150E−07 | 5.34740E−08 | −1.83610E−09 |
| R4 | 17.36679E+01 | −4.84770E−05 | 3.52920E−06 | −1.46320E−07 | 2.11770E−09 |
| R5 | −2.60601E+00 | −3.95630E−05 | 2.45750E−06 | −6.68290E−08 | −7.51320E−10 |
| R6 | −1.54843E+01 | 5.82290E−04 | −1.13720E−04 | 1.45970E−05 | −1.09910E−06 |
| R7 | −7.30030E−01 | 9.53330E−05 | −2.04250E−05 | 2.94780E−06 | −2.40840E−07 |
| R8 | −1.51169E+01 | −4.20080E−07 | −5.36820E−06 | 1.18080E−06 | −1.09370E−07 |
| R9 | −4.65434E−01 | 1.23970E−04 | −2.20620E−05 | 2.55550E−06 | −1.71870E−07 |
| R10 | 7.40553E+01 | 3.57540E−05 | −4.20630E−06 | 3.08240E−07 | −1.28150E−08 |

| | Conic Index | Aspherical Surface Index |
|---|---|---|
| | k | A20 |
| Rp1 | −7.28771E+01 | 3.58110E−15 |
| Rp2 | 0.00000E+00 | 0.00000E+00 |
| R1 | 9.99000E+02 | 5.29190E−11 |
| R2 | 1.01496E−01 | 1.01690E−13 |
| R3 | −1.32923E+01 | 1.32960E−12 |
| R4 | −7.36679E+01 | 1.20760E−13 |
| R5 | −2.60601E+00 | 6.76000E−11 |
| R6 | −1.54843E+01 | 3.66710E−08 |
| R7 | −7.30030E−01 | 8.26480E−09 |
| R8 | −1.51169E+01 | 3.86440E−09 |
| R9 | −4.65434E−01 | 5.06380E−09 |
| R10 | 7.40553E+01 | 2.30850E−10 |

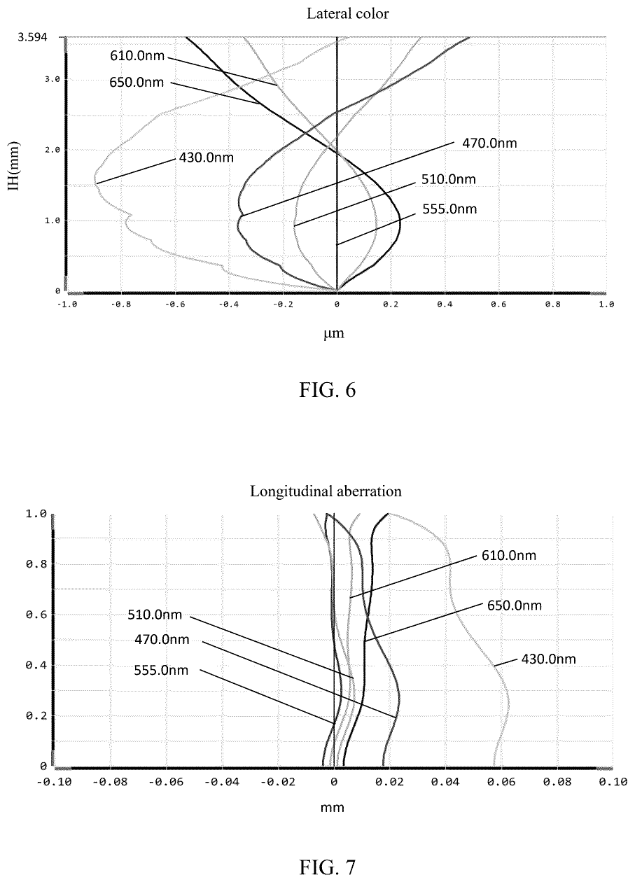

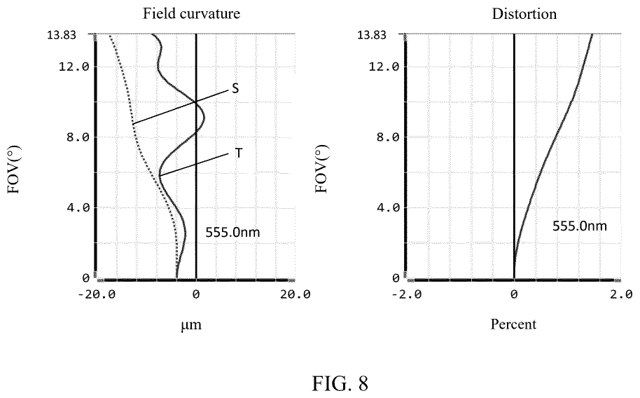

FIG. 6 and FIG. 7 show the lateral color and longitudinal aberration schematic diagrams after light with a wavelength of 650 nm, 610 nm, 555 nm, 510 nm, 470 nm and 430 nm passes the camera optical lens 20 in the second embodiment. FIG. 8 shows the field curvature and distortion schematic diagrams after light with a wavelength of 555 nm passes the camera optical lens 20 in the second embodiment, the field curvature S in FIG. 8 is a field curvature in the sagittal direction, T is a field curvature in the meridian direction.

As shown in Table 19, the second embodiment satisfies all conditional expressions.

In this embodiment, the pupil entering diameter (ENPD) of the camera optical lens 20 is 7.249 mm, the full-field image height (IH) is 3.594 mm, and the diagonal field of view (FOV) is 27.67°. This design satisfies the requirements of long focal length, high magnification, and miniaturization, while exhibiting excellent optical characteristics.

### Embodiment 3

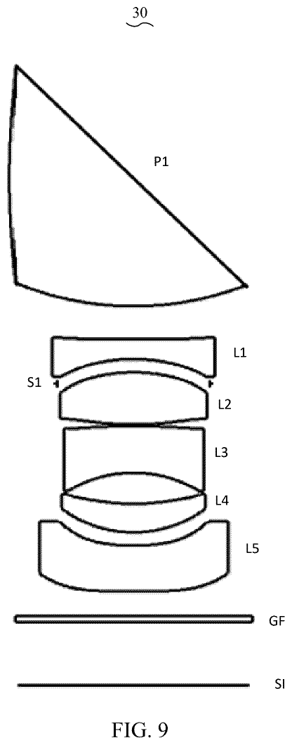

Embodiment 3 is basically the same as embodiment 1, the meaning of its symbols is the same as that of embodiment 1, the structural configuration of the camera optical lens 30 according to the third embodiment is illustrated in FIG. 9, and in the following, only the differences are described.

Table 7 present the design data of the camera optical lens 30 according to the third embodiment of the present disclosure, in which, d1=“dp1-01”+“dp1-02”, “dp1-01”=4.195 mm, and “dp1-02”=4.505 mm.

TABLE 7
Design data of the camera optical lens 30

| | R | d | | nd | | vd | |
|---|---|---|---|---|---|---|---|
| S1 | ∞ | d0= | −11.026 | | | | |
| Rp1 | 25.224 | dp1= | 8.700 | nd1 | 1.8088 | vd1 | 40.91 |
| Rp2 | −10.086 | dp2= | dp2 | | | | |
| R1 | 282.451 | d1= | 0.700 | nd2 | 1.6400 | vd2 | 23.54 |
| R2 | 5.320 | d2= | 0.466 | | | | |
| R3 | 5.343 | d3= | 1.829 | nd3 | 1.5444 | vd3 | 55.82 |
| R4 | −12.505 | d4= | 0.064 | | | | |
| R5 | 18.046 | d5= | 1.639 | nd4 | 1.6153 | vd4 | 25.94 |
| R6 | 4.219 | d6= | 1.097 | | | | |
| R7 | −5.933 | d7= | 1.000 | nd5 | 1.6700 | vd5 | 19.39 |
| R8 | −3.604 | d8= | 0.460 | | | | |
| R9 | −7.811 | d9= | 1.600 | nd6 | 1.5346 | vd6 | 55.69 |
| R10 | 70.298 | d10= | d10 | | | | |
| R11 | ∞ | d11= | 0.210 | ndg | 1.5168 | vdg | 64.17 |
| R12 | ∞ | d12= | 2.134 | | | | |

Table 8 presents the data of relevant optical parameters for the camera optical lens 30 according to the third embodiment of the present disclosure in both the first state (infinity focus state) and the second state (macro focus state).

TABLE 8
Relevant Optical Parameters of Camera Optical
Lens 30 in Different Focus States

| | First state | Second state |
|---|---|---|
| f | 14.267 | 13.340 |
| FOV | 27.87° | 26.81° |
| FNO | 1.97 | 1.84 |
| dp2 | 1.160 | 1.933 |
| d10 | 0.889 | 0.116 |

Table 9 shows the aspherical surface data of the camera optical lens 30 in the embodiment 3 of the present disclosure.

TABLE 9
Aspherical surface data of the camera optical lens 30

| | Conic Index | Aspherical Surface Index | | | |
|---|---|---|---|---|---|
| | k | A4 | A6 | A8 | A10 |
| Rp1 | −2.31937E+01 | −9.85140E−05 | −7.10660E−06 | −9.00710E−08 | 1.47800E−08 |
| Rp2 | 0.00000E+00 | 0.00000E+00 | 0.00000E+00 | 0.00000E+00 | 0.00000E+00 |
| R1 | 9.99000E+02 | −3.54400E−03 | 5.60340E−04 | −3.17090E−05 | −9.89690E−06 |
| R2 | 1.28804E+00 | −5.74520E−03 | 1.45950E−03 | −1.88010E−04 | 3.14190E−05 |
| R3 | −1.09876E+01 | 7.28150E−03 | −4.91480E−04 | 2.63240E−04 | −4.21710E−05 |
| R4 | −1.56338E−01 | −1.10850E−02 | 6.86960E−03 | −2.10310E−03 | 4.15060E−04 |
| R5 | 2.77620E+01 | −1.06380E−02 | 5.88230E−03 | −1.88030E−03 | 3.52850E−04 |
| R6 | −1.87924E+01 | 3.33290E−02 | −1.49470E−02 | 8.18260E−03 | −3.91400E−03 |
| R7 | −3.44307E+00 | 8.05940E−03 | −2.42270E−03 | 9.99470E−04 | −3.24810E−04 |
| R8 | −9.38434E+00 | −1.56780E−02 | 2.39950E−03 | −1.33300E− | −4.03420E− |
| | | | | 05 | 04 |
| R9 | 4.03878E−01 | −6.39190E−03 | −3.64930E−03 | 1.11880E−03 | −3.54890E−06 |
| R10 | 4.33046E+02 | −8.83970E−03 | −3.23320E−04 | 3.78100E−04 | −1.25870E−04 |

| | Conic Index | Aspherical Surface Index | | | |
|---|---|---|---|---|---|
| | k | A12 | A14 | A16 | A18 |
| Rp1 | −2.31937E+01 | −1.11200E−09 | −3.60380E−11 | 8.21410E−12 | −3.89070E−13 |
| Rp2 | 0.00000E+00 | 0.00000E+00 | 0.00000E+00 | 0.00000E+00 | 0.00000E+00 |
| R1 | 9.99000E+02 | 3.05630E−06 | −4.71070E−07 | 4.47900E−08 | −2.40270E−09 |
| R2 | 1.28804E+00 | −3.84660E−06 | −2.03870E−08 | 2.59120E−08 | −8.83210E−10 |
| R3 | −1.09876E+01 | 5.43230E−06 | −6.63780E−07 | 5.34740E−08 | −1.83610E−09 |
| R4 | −1.56338E−01 | −4.93420E−05 | 3.52540E−06 | −1.46320E−07 | 2.11770E−09 |
| R5 | 2.77620E+01 | −4.01070E−05 | 2.45750E−06 | −6.68290E−08 | −7.51320E−10 |
| R6 | −1.87924E+01 | 1.45440E−03 | −3.89430E−04 | 6.85910E−05 | −7.00280E−06 |
| R7 | −3.44307E+00 | 8.82820E−05 | −2.04250E−05 | 2.94780E−06 | −2.40840E−07 |
| R8 | −9.38434E+00 | 2.62480E−04 | −8.89850E−05 | 1.71130E−05 | −1.79110E−06 |
| R9 | 4.03878E−01 | −1.26370E−04 | 4.83330E−05 | −9.00520E−06 | 8.64220E−07 |
| R10 | 4.33046E+02 | 2.50670E−05 | −3.18560E−06 | 2.51720E−07 | −1.12890E−08 |

| | |
|---|---|
| Conic Index | Aspherical Surface Index |

| | k | A20 |
|---|---|---|
| Rp1 | −2.31937E+01 | 6.12610E−15 |
| Rp2 | 0.00000E+00 | 0.00000E+00 |
| R1 | 9.99000E+02 | 5.29190E−11 |
| R2 | 1.28804E+00 | 1.01690E−13 |
| R3 | −1.09876E+01 | 1.32960E−12 |
| R4 | −1.56338E−01 | 1.20760E−13 |
| R5 | 2.77620E+01 | 6.76000E−11 |
| R6 | −1.87924E+01 | 3.11340E−07 |
| R7 | −3.44307E+00 | 8.26480E−09 |
| R8 | −9.38434E+00 | 8.00890E−08 |
| R9 | 4.03878E−01 | −3.32540E−08 |
| R10 | 4.33046E+02 | 2.20220E−10 |

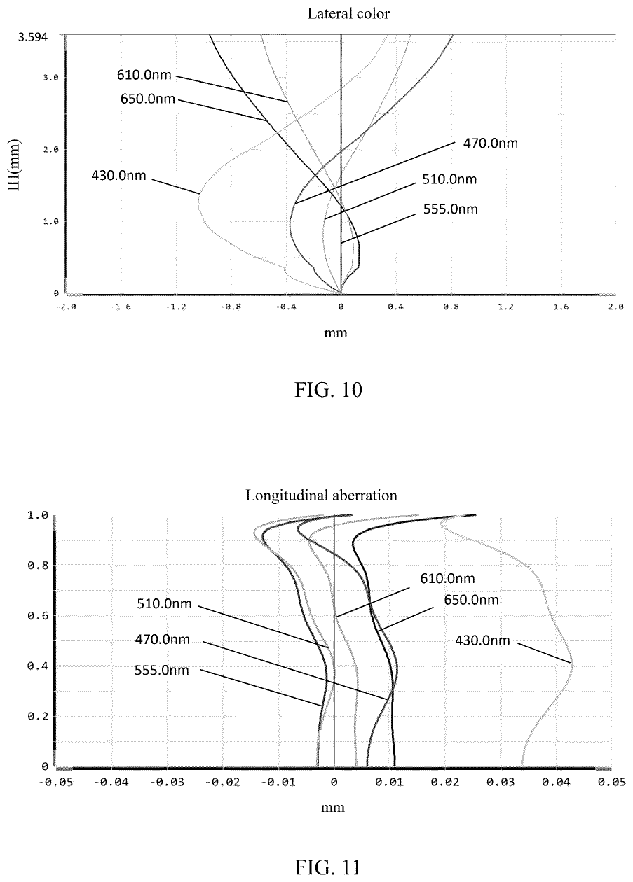

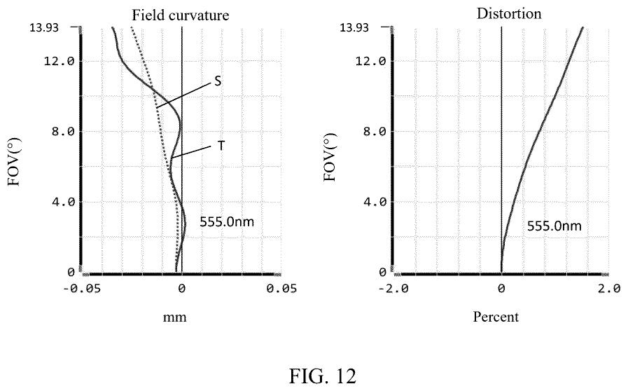

FIG. 10 and FIG. 11 show the lateral color and longitudinal aberration schematic diagrams after light with a wavelength of 650 nm, 610 nm, 555 nm, 510 nm, 470 nm and 430 nm passes the camera optical lens 30 in the third embodiment. FIG. 12 shows the field curvature and distortion schematic diagrams after light with a wavelength of 555 nm passes the camera optical lens 30 in the third embodiment, the field curvature S in FIG. 12 is a field curvature in the sagittal direction, T is a field curvature in the meridian direction.

As shown in Table 19, the third embodiment satisfies all conditional expressions.

In this embodiment, the pupil entering diameter (ENPD) of the camera optical lens 30 is 7.249 mm, the full-field image height (IH) is 3.594 mm, and the diagonal field of view (FOV) is 27.87°. This design satisfies the requirements of long focal length, high magnification, and miniaturization, while exhibiting excellent optical characteristics.

### Embodiment 4

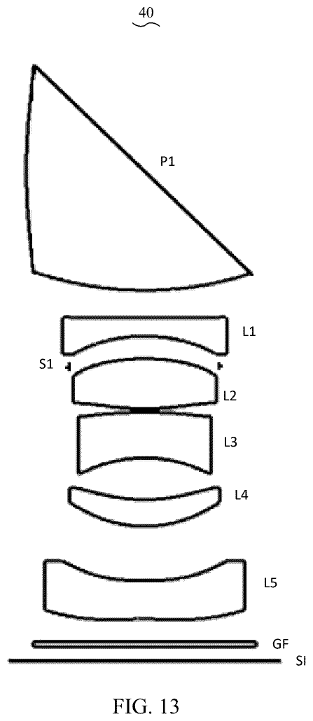

Embodiment 4 is basically the same as embodiment 1, the meaning of its symbols is the same as that of embodiment 1, the structural configuration of the camera optical lens 40 according to the fourth embodiment is illustrated in FIG. 13, and in the following, only the differences are described.

Table 10 present the design data of the camera optical lens 40 according to the fourth embodiment of the present disclosure, in which, d1=“dp1-01”+“dp1-02”, “dp1-01”=4.260 mm, and “dp1-02”=4.440 mm.

TABLE 10
Design data of the camera optical lens 40

| | R | d | | nd | | vd | |
|---|---|---|---|---|---|---|---|
| S1 | ∞ | d0= | −11.260 | | | | |
| Rp1 | 22.566 | dp1= | 8.700 | nd1 | 1.8052 | vd1 | 40.91 |
| Rp2 | −11.871 | dp2= | dp2 | | | | |
| R1 | 89.077 | d1= | 0.700 | nd2 | 1.6400 | vd2 | 23.54 |
| R2 | 5.125 | d2= | 0.842 | | | | |
| R3 | 6.652 | d3= | 1.869 | nd3 | 1.5444 | vd3 | 55.82 |
| R4 | −10.602 | d4= | 0.134 | | | | |
| R5 | 12.669 | d5= | 1.710 | nd4 | 1.6153 | vd4 | 25.94 |
| R6 | 4.946 | d6= | 1.562 | | | | |
| R7 | −5.318 | d7= | 1.000 | nd5 | 1.6700 | vd5 | 19.39 |
| R8 | −4.084 | d8= | 2.032 | | | | |
| R9 | −10.566 | d9= | 1.435 | nd6 | 1.5346 | vd6 | 55.69 |
| R10 | 27.927 | d10= | d10 | | | | |
| R11 | ∞ | d11= | 0.210 | ndg | 1.5168 | vdg | 64.17 |
| R12 | ∞ | d12= | 0.513 | | | | |

Table 11 presents the data of relevant optical parameters for the camera optical lens 40 according to the fourth embodiment of the present disclosure in both the first state (infinity focus state) and the second state (macro focus state).

TABLE 11
Relevant Optical Parameters of Camera Optical
Lens 40 in Different Focus States

| | First state | Second state |
|---|---|---|
| f | 14.376 | 13.467 |
| FOV | 27.55° | 26.89° |
| FNO | 1.98 | 1.86 |
| dp2 | 1.018 | 1.770 |
| d10 | 0.842 | 0.090 |

Table 12 shows the aspherical surface data of the camera optical lens 40 in the embodiment 4 of the present disclosure.

TABLE 12
Aspherical surface data of the camera optical lens 40

| | Conic Index | Aspherical Surface Index | | | |
|---|---|---|---|---|---|
| | k | A4 | A6 | A8 | A10 |
| Rp1 | −1.73044E+01 | −6.50910E−05 | −5.95720E−06 | −1.22230E−07 | 1.62550E−08 |
| Rp2 | 0.00000E+00 | 0.00000E+00 | 0.00000E+00 | 0.00000E+00 | 0.00000E+00 |
| R1 | 8.90396E+02 | −3.43370E−03 | 6.17210E−04 | −3.40550E−05 | −9.80380E−06 |
| R2 | 1.09161E+00 | −6.01000E−03 | 1.30750E−03 | −1.84810E−04 | 3.17400E−05 |
| R3 | −1.97217E+01 | 6.20540E−03 | −5.42090E−04 | 2.55380E−04 | −4.24000E−05 |
| R4 | −5.61801E+00 | −1.06280E−02 | 6.93500E−03 | −2.09730E−03 | 4.12390E−04 |
| R5 | 1.57023E+01 | −1.02400E−02 | 5.75010E−03 | −1.89070E−03 | 3.51290E−04 |
| R6 | −2.75158E+01 | 2.99010E−02 | −1.31490E−02 | 6.06100E−03 | −2.22740E−03 |
| R7 | −1.07491E+00 | 6.65570E−03 | −2.45130E−03 | 9.87750E−04 | −3.17940E−04 |
| R8 | −9.35937E+00 | −1.27230E−02 | 1.75170E−03 | −2.53730E−04 | −5.72290E−06 |
| R9 | −7.38459E+00 | −4.76230E−03 | −1.82950E−03 | 5.65700E−04 | −8.75600E−05 |
| R10 | 5.55298E+01 | −3.79520E−03 | −9.05160E−04 | 7.14510E−06 | 7.98600E−05 |
| | Conic Index | Aspherical Surface Index | | | |
| | k | A12 | A14 | A16 | A18 |
| Rp1 | −1.73044E+01 | −1.03390E−09 | −3.21880E−11 | 7.94500E−12 | −4.02560E−13 |
| Rp2 | 0.00000E+00 | 0.00000E+00 | 0.00000E+00 | 0.00000E+00 | 0.00000E+00 |
| R1 | 8.90396E+02 | 3.04090E−06 | −4.78680E−07 | 4.53920E−08 | −2.40270E−09 |
| R2 | 1.09161E+00 | −3.82450E−06 | −3.54060E−09 | 2.59120E−08 | −8.83210E−10 |
| R3 | −1.97217E+01 | 5.66630E−06 | −6.88500E−07 | 5.34740E−08 | −1.83610E−09 |
| R4 | −5.61801E+00 | −5.02790E−05 | 3.63650E−06 | −1.46320E−07 | 2.11770E−09 |
| R5 | 1.57023E+01 | −4.01290E−05 | 2.45750E−06 | −6.68290E−08 | −7.51320E−10 |
| R6 | −2.75158E+01 | 5.86410E−04 | −1.05710E−04 | 1.22960E−05 | −8.31500E−07 |
| R7 | −1.07491E+00 | 9.22670E−05 | −2.04250E−05 | 2.94780E−06 | −2.40840E−07 |
| R8 | −9.35937E+00 | 2.44290E−05 | −7.95830E−06 | 1.24930E−06 | −9.93390E−08 |
| R9 | −7.38459E+00 | 1.48770E−05 | −2.80470E−06 | 3.50530E−07 | −2.29020E−08 |
| R10 | 5.55298E+01 | −2.09980E−05 | 2.68170E−06 | −1.94230E−07 | 7.67660E−09 |

| | |
|---|---|
| Conic Index | Aspherical Surface Index |

| | k | A20 |
|---|---|---|
| Rp1 | −1.73044E+01 | 6.92930E−15 |
| Rp2 | 0.00000E+00 | 0.00000E+00 |
| R1 | 8.90396E+02 | 5.29190E−11 |
| R2 | 1.09161E+00 | 1.01690E−13 |
| R3 | −1.97217E+01 | 1.32960E−12 |
| R4 | −5.61801E+00 | 1.20760E−13 |
| R5 | 1.57023E+01 | 6.76000E−11 |
| R6 | −2.75158E+01 | 2.48840E−08 |
| R7 | −1.07491E+00 | 8.26480E−09 |
| R8 | −9.35937E+00 | 3.17930E−09 |
| R9 | −7.38459E+00 | 5.99870E−10 |
| R10 | 5.55298E+01 | −1.29350E−10 |

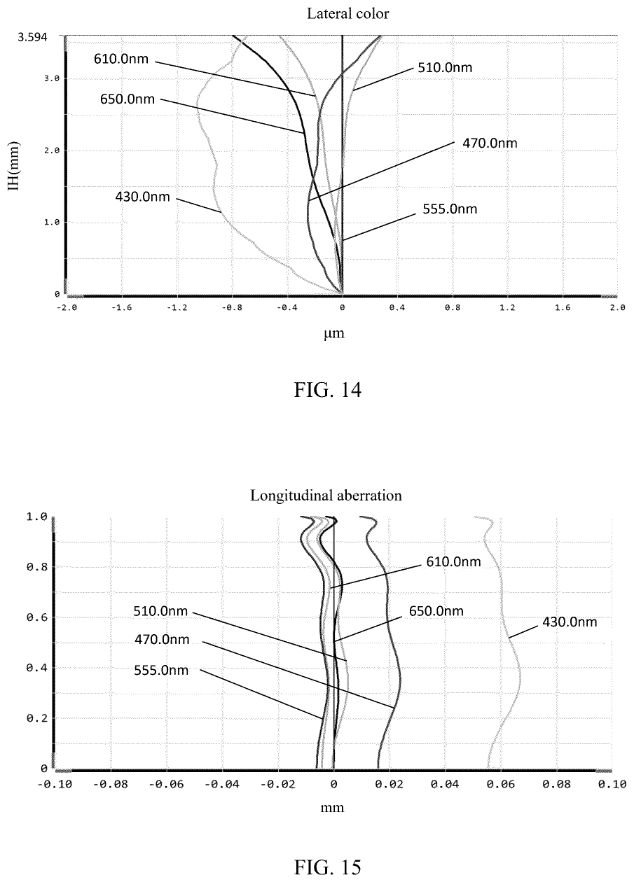

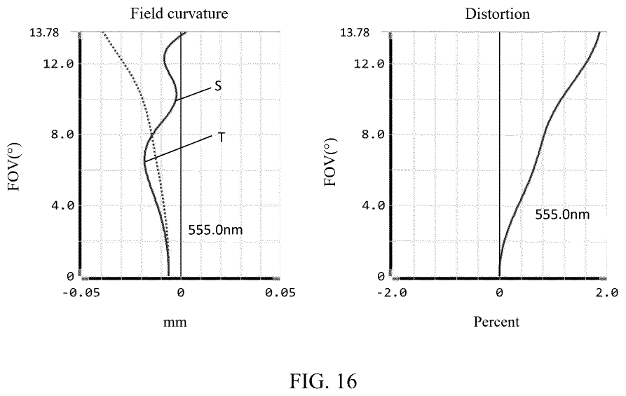

FIG. 14 and FIG. 15 show the lateral color and longitudinal aberration schematic diagrams after light with a wavelength of 650 nm, 610 nm, 555 nm, 510 nm, 470 nm and 430 nm passes the camera optical lens 40 in the fourth embodiment. FIG. 16 shows the field curvature and distortion schematic diagrams after light with a wavelength of 555 nm passes the camera optical lens 40 in the fourth embodiment, the field curvature S in FIG. 16 is a field curvature in the sagittal direction, T is a field curvature in the meridian direction.

As shown in Table 19, the fourth embodiment satisfies all conditional expressions.

In this embodiment, the pupil entering diameter (ENPD) of the camera optical lens 40 is 7.249 mm, the full-field image height (IH) is 3.594 mm, and the diagonal field of view (FOV) is 27.55°. This design satisfies the requirements of long focal length, high magnification, and miniaturization, while exhibiting excellent optical characteristics.

### Embodiment 5

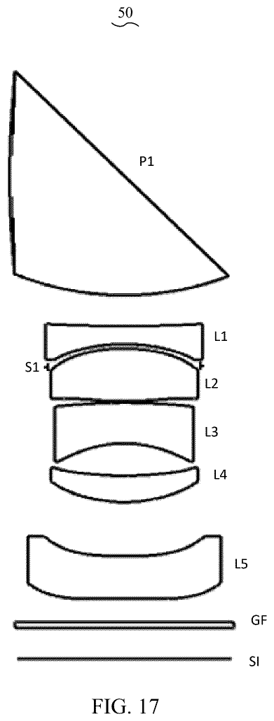

Embodiment 5 is basically the same as embodiment 1, the meaning of its symbols is the same as that of embodiment 1, the structural configuration of the camera optical lens 50 according to the fifth embodiment is illustrated in FIG. 17, and in the following, only the differences are described.

Table 13 present the design data of the camera optical lens 50 according to the fifth embodiment of the present disclosure, in which, d1=“dp1-01”+“dp1-02”, “dp1-01”=4.180 mm, and “dp1-02”=4.520 mm.

TABLE 10
Design data of the camera optical lens 50

| | R | d | | nd | | vd | |
|---|---|---|---|---|---|---|---|
| S1 | ∞ | d0= | −10.720 | | | | |
| Rp1 | 30.912 | dp1= | 8.700 | nd1 | 1.8052 | vd1 | 40.91 |
| Rp2 | −10.301 | dp2= | dp2 | | | | |
| R1 | 244.900 | d1= | 0.700 | nd2 | 1.6400 | vd2 | 23.54 |
| R2 | 5.776 | d2= | 0.162 | | | | |
| R3 | 5.646 | d3= | 2.000 | nd3 | 1.5444 | vd3 | 55.82 |
| R4 | −16.544 | d4= | 0.061 | | | | |
| R5 | 14.922 | d5= | 1.538 | nd4 | 1.6153 | vd4 | 25.94 |
| R6 | 3.855 | d6= | 1.235 | | | | |
| R7 | −10.289 | d7= | 1.000 | nd5 | 1.6700 | vd5 | 19.39 |
| R8 | −4.991 | d8= | 2.058 | | | | |
| R9 | −15.257 | d9= | 1.600 | nd6 | 1.5346 | vd6 | 55.69 |
| R10 | 28.335 | d10= | d10 | | | | |
| R11 | ∞ | d11= | 0.210 | ndg | 1.5168 | vg | 64.17 |
| R12 | ∞ | d12= | 1.18 | | | | |

Table 14 presents the data of relevant optical parameters for the camera optical lens 50 according to the fifth embodiment of the present disclosure in both the first state (infinity focus state) and the second state (macro focus state).

TABLE 14
Relevant Optical Parameters of Camera Optical
Lens 50 in Different Focus States

| | First state | Second state |
|---|---|---|
| f | 14.376 | 13.405 |
| FOV | 27.56° | 26.65° |
| FNO | 1.98 | 1.85 |
| dp2 | 1.158 | 1.970 |
| d10 | 0.908 | 0.096 |

Table 15 shows the aspherical surface data of the camera optical lens 50 in the embodiment 5 of the present disclosure.

TABLE 15
Aspherical surface data of the camera optical lens 50

| | Conic Index | Aspherical Surface Index | | | |
|---|---|---|---|---|---|
| | k | A4 | A6 | A8 | A10 |
| Rp1 | −3.43544E+01 | −1.09070E−04 | −5.37620E−06 | −1.14230E−07 | 1.28150E−08 |
| Rp2 | 0.00000E+00 | 0.00000E+00 | 0.00000E+00 | 0.00000E+00 | 0.00000E+00 |
| R1 | 9.99000E+02 | −3.64640E−03 | 4.35390E−04 | −5.37440E−06 | −9.34140E−06 |
| R2 | 7.96467E−01 | −7.19180E−03 | 1.60930E−03 | −1.94990E−04 | 3.42590E−05 |
| R3 | −1.48761E+01 | 7.07530E−03 | −5.86760E−04 | 2.59640E−04 | −4.15100E−05 |
| R4 | −4.04074E+01 | −9.95600E−03 | 6.87860E−03 | −2.12800E−03 | 4.12370E−04 |
| R5 | 1.12801E+01 | −1.21430E−02 | 6.09600E−03 | −1.86730E−03 | 3.54410E−04 |
| R6 | −1.43787E+01 | 2.73180E−02 | −1.29200E−02 | 5.95220E−03 | −2.22520E−03 |
| R7 | 3.28761E+00 | 5.98800E−03 | −2.10580E−03 | 8.87890E−04 | −3.35680E−04 |
| R8 | −1.53884E+01 | −1.15780E−02 | 2.31200E−03 | −3.83500E−04 | −5.14960E−05 |
| R9 | −1.59853E+01 | −4.16010E−03 | −2.07140E−03 | 1.10320E−03 | −3.82270E−04 |
| R10 | 5.62503E+01 | −3.97990E−03 | −1.80400E−03 | 8.57910E−04 | −2.33160E−04 |
| | Conic Index | Aspherical Surface Index | | | |
| | k | A12 | A14 | A16 | A18 |
| Rp1 | −3.43544E+01 | −1.01570E−09 | −2.65680E−11 | 7.76840E−12 | −3.83820E−13 |
| Rp2 | 0.00000E+00 | 0.00000E+00 | 0.00000E+00 | 0.00000E+00 | 0.00000E+00 |
| R1 | 9.99000E+02 | 2.86060E−06 | −4.84610E−07 | 4.65810E−08 | −2.40270E−09 |
| R2 | 7.96467E−01 | −3.18020E−06 | −9.78000E−08 | 2.59120E−08 | −8.83210E−10 |
| R3 | −1.48761E+01 | 5.38330E−06 | −6.74910E−07 | 5.34740E−08 | −1.83610E−09 |
| R4 | −4.04074E+01 | −4.88050E−05 | 3.52100E−06 | −1.46320E−07 | 2.11770E−09 |
| R5 | 1.12801E+01 | −4.00080E−05 | 2.45750E−06 | −6.68290E−08 | −7.51320E−10 |
| R6 | −1.43787E+01 | 6.13470E−04 | −1.17970E−04 | 1.48870E−05 | −1.10200E−06 |
| R7 | 3.28761E+00 | 9.49320E−05 | −2.04250E−05 | 2.94780E−06 | −2.40840E−07 |
| R8 | −1.53884E+01 | 5.45030E−05 | −1.67730E−05 | 2.67850E−06 | −2.21270E−07 |
| R9 | −1.59853E+01 | 8.59750E−05 | −1.27450E−05 | 1.20700E−06 | −6.65540E−08 |
| R10 | 5.62503E+01 | 3.93030E−05 | −4.20150E−06 | 2.77520E−07 | −1.03500E−08 |

| | Conic Index | Aspherical Surface Index |
|---|---|---|
| | k | A20 |
| Rp1 | −3.43544E+01 | 5.83970E−15 |
| Rp2 | 0.00000E+00 | 0.00000E+00 |
| R1 | 9.99000E+02 | 5.29190E−11 |
| R2 | 7.96467E−01 | 1.01690E−13 |
| R3 | −1.48761E+01 | 1.32960E−12 |
| R4 | −4.04074E+01 | 1.20760E−13 |
| R5 | 1.12801E+01 | 6.76000E−11 |
| R6 | −1.43787E+01 | 3.60850E−08 |
| R7 | 3.28761E+00 | 8.26480E−09 |
| R8 | −1.53884E+01 | 7.49290E−09 |
| R9 | −1.59853E+01 | 1.64370E−09 |
| R10 | 5.62503E+01 | 1.66810E−10 |

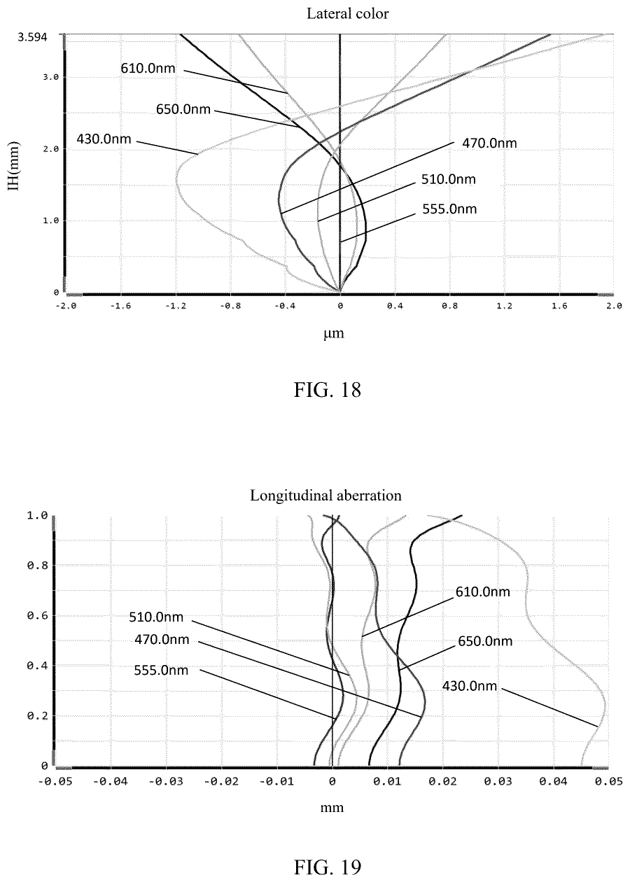

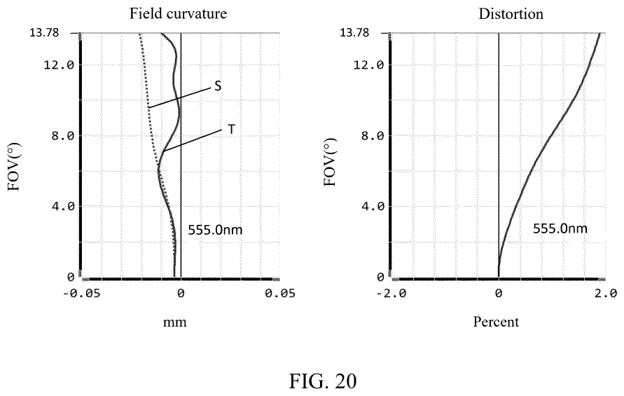

FIG. 18 and FIG. 19 show the lateral color and longitudinal aberration schematic diagrams after light with a wavelength of 650 nm, 610 nm, 555 nm, 510 nm, 470 nm and 430 nm passes the camera optical lens 50 in the fifth embodiment. FIG. 20 shows the field curvature and distortion schematic diagrams after light with a wavelength of 555 nm passes the camera optical lens 50 in the fifth embodiment, the field curvature S in FIG. 20 is a field curvature in the sagittal direction, T is a field curvature in the meridian direction.

As shown in Table 19, the fifth embodiment satisfies all conditional expressions.

In this embodiment, the pupil entering diameter (ENPD) of the camera optical lens 50 is 7.252 mm, the full-field image height (IH) is 3.594 mm, and the diagonal field of view (FOV) is 27.56°. This design satisfies the requirements of long focal length, high magnification, and miniaturization, while exhibiting excellent optical characteristics.

### Embodiment 6

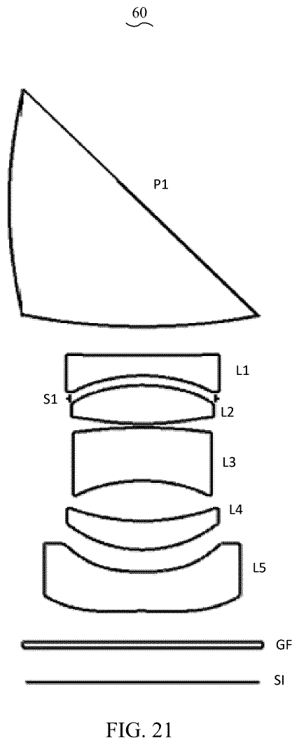

Embodiment 6 is basically the same as embodiment 1, the meaning of its symbols is the same as that of embodiment 1, the structural configuration of the camera optical lens 60 according to the sixth embodiment is illustrated in FIG. 21, and in the following, only the differences are described.

Table 16 present the design data of the camera optical lens 60 according to the sixth embodiment of the present disclosure, in which, d1=“dp1-01”+“dp1-02”, “dp1-01”=4.445 mm, and “dp1-02”=4.255 mm.

TABLE 16
Design data of the camera optical lens 60

| | R | d | | nd | | vd | |
|---|---|---|---|---|---|---|---|
| S1 | ∞ | d0= | −10.740 | | | | |
| Rp1 | 15.739 | dp1= | 8.700 | nd1 | 1.8052 | vd1 | 40.91 |
| Rp2 | −19.649 | dp2= | dp2 | | | | |
| R1 | 266.629 | d1= | 0.700 | nd2 | 1.6400 | vd2 | 23.54 |
| R2 | 4.984 | d2= | 0.340 | | | | |
| R3 | 5.358 | d3= | 1.328 | nd3 | 1.5444 | vd3 | 55.82 |
| R4 | −11.140 | d4= | 0.137 | | | | |
| R5 | 13.667 | d5= | 1.842 | nd4 | 1.6153 | vd4 | 25.94 |
| R6 | 5.642 | d6= | 1.391 | | | | |
| R7 | −5.952 | d7= | 1.000 | nd5 | 1.6700 | vd5 | 19.39 |
| R8 | −3.652 | d8= | 0.767 | | | | |
| R9 | −6.342 | d9= | 1.356 | nd6 | 1.5346 | vd6 | 55.69 |
| R10 | 25.445 | d10= | d10 | | | | |
| R11 | ∞ | d11= | 0.210 | ndg | 1.5168 | vdg | 64.17 |
| R12 | ∞ | d12= | 1.202 | | | | |

Table 17 presents the data of relevant optical parameters for the camera optical lens 60 according to the sixth embodiment of the present disclosure in both the first state (infinity focus state) and the second state (macro focus state).

TABLE 17
Relevant Optical Parameters of Camera Optical
Lens 60 in Different Focus States

| | First state | Second state |
|---|---|---|
| f | 14.383 | 13.953 |
| FOV | 27.55° | 26.83° |
| FNO | 1.98 | 1.92 |
| dp2 | 1.000 | 1.983 |
| d10 | 1.075 | 0.092 |

Table 18 shows the aspherical surface data of the camera optical lens 60 in the embodiment 6 of the present disclosure.

TABLE 18
Aspherical surface data of the camera optical lens 60

| | Conic Index | Aspherical Surface Index | | | |
|---|---|---|---|---|---|
| | k | A4 | A6 | A8 | A10 |
| Rp1 | −5.78045E+00 | 5.29460E−05 | −3.10400E−06 | −7.07310E−08 | 1.53260E−08 |
| Rp2 | 0.00000E+00 | 0.00000E+00 | 0.00000E+00 | 0.00000E+00 | 0.00000E+00 |
| R1 | −9.99000E+02 | −3.51820E−03 | 5.89000E−04 | −2.95270E−05 | −9.52530E−06 |
| R2 | 1.13625E+00 | −6.10580E−03 | 1.40570E−03 | −1.81220E−04 | 3.19670E−05 |
| R3 | −1.18387E+01 | 7.35780E−03 | −5.01340E−04 | 2.58120E−04 | −4.19400E−05 |
| R4 | 1.07983E+00 | −1.12110E−02 | 6.86650E−03 | −2.10000E−03 | 4.12700E−04 |
| R5 | 2.39599E+01 | −1.03960E−02 | 5.89070E−03 | −1.89080E−03 | 3.51330E−04 |
| R6 | −2.84355E+01 | 2.25510E−02 | −8.22900E−03 | 4.07080E−03 | −1.74640E−03 |
| R7 | −1.32062E+00 | 6.84240E−03 | −2.76850E−03 | 9.79620E−04 | −3.18790E−04 |
| R8 | −8.51666E+00 | −1.27340E−02 | 9.34970E−04 | −2.18370E−04 | 1.03890E−04 |
| R9 | −2.66284E−01 | −3.07790E−03 | −6.02450E−03 | 1.99570E−03 | −2.93580E−04 |
| R10 | 5.17312E+01 | −7.28820E−03 | −1.90000E−03 | 7.86940E−04 | −1.56440E−04 |
| | Conic Index | Aspherical Surface Index | | | |
| | k | A12 | A14 | A16 | A18 |
| Rp1 | −5.78045E+00 | −1.05770E−09 | −3.26800E−11 | 8.15580E−12 | −4.07380E−13 |
| Rp2 | 0.00000E+00 | 0.00000E+00 | 0.00000E+00 | 0.00000E+00 | 0.00000E+00 |
| R1 | −9.99000E+02 | 3.05920E−06 | −4.76400E−07 | 4.46650E−08 | −2.40270E−09 |
| R2 | 1.13625E+00 | −3.95800E−06 | −3.01240E−08 | 2.59120E−08 | −8.83210E−10 |
| R3 | −1.18387E+01 | 5.60010E−06 | −6.85430E−07 | 5.34740E−08 | −1.83610E−09 |
| R4 | 1.07983E+00 | −4.98980E−05 | 3.62490E−06 | −1.46320E−07 | 2.11770E−09 |
| R5 | 2.39599E+01 | −4.04650E−05 | 2.45750E−06 | −6.68290E−08 | −7.51320E−10 |
| R6 | −2.84355E+01 | 5.80160E−04 | −1.40950E−04 | 2.31580E−05 | −2.28450E−06 |
| R7 | −1.32062E+00 | 9.15130E−05 | −2.04250E−05 | 2.94780E−06 | −2.40840E−07 |
| R8 | −8.51666E+00 | −2.57900E−05 | 1.97100E−06 | 3.48720E−07 | −8.28600E−08 |
| R9 | −2.66284E−01 | −3.44970E−06 | 9.64600E−06 | −1.76860E−06 | 1.48590E−07 |
| R10 | 5.17312E+01 | 1.83760E−05 | −1.24990E−06 | 3.99300E−08 | 4.77170E−11 |

| Conic Index | Aspherical Surface Index | |
|---|---|---|
| | k | A20 |
| Rp1 | −5.78045E+00 | 6.89520E−15 |
| Rp2 | 0.00000E+00 | 0.00000E+00 |
| R1 | −9.99000E+02 | 5.29190E−11 |
| R2 | 1.13625E+00 | 1.01690E−13 |
| R3 | −1.18387E+01 | 1.32960E−12 |
| R4 | 1.07983E+00 | 1.20760E−13 |
| R5 | 2.39599E+01 | 6.76000E−11 |
| R6 | −2.84355E+01 | 1.01830E−07 |
| R7 | −1.32062E+00 | 8.26480E−09 |
| R8 | −8.51666E+00 | 5.09210E−09 |
| R9 | −2.66284E−01 | −4.92720E−09 |
| R10 | 5.17312E+01 | −2.59680E−11 |

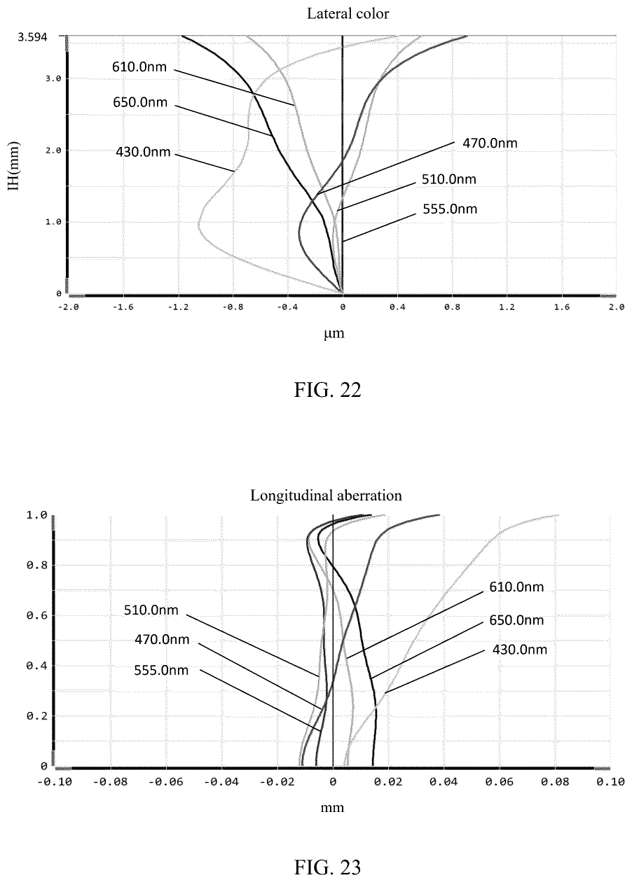

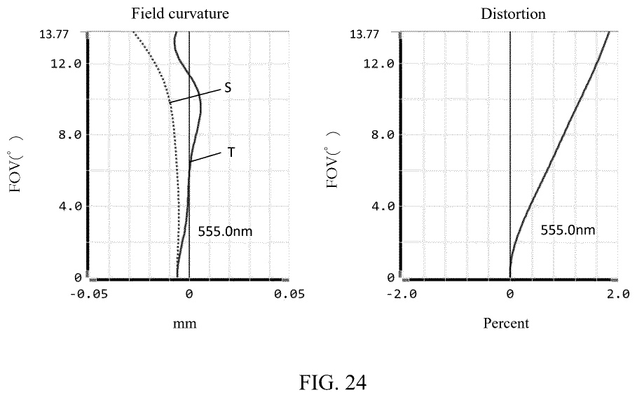

FIG. 22 and FIG. 23 show the lateral color and longitudinal aberration schematic diagrams after light with a wavelength of 650 nm, 610 nm, 555 nm, 510 nm, 470 nm and 430 nm passes the camera optical lens 60 in the sixth embodiment. FIG. 24 shows the field curvature and distortion schematic diagrams after light with a wavelength of 555 nm passes the camera optical lens 60 in the sixth embodiment, the field curvature S in FIG. 24 is a field curvature in the sagittal direction, T is a field curvature in the meridian direction.

As shown in Table 19, the sixth embodiment satisfies all conditional expressions.

In this embodiment, the pupil entering diameter (ENPD) of the camera optical lens 60 is 7.252 mm, the full-field image height (IH) is 3.594 mm, and the diagonal field of view (FOV) is 27.55°. This design satisfies the requirements of long focal length, high magnification, and miniaturization, while exhibiting excellent optical characteristics.

TABLE 19
Values corresponding to various parameters specified in the conditions of each embodiment

| Parameters | | | | | | |
|---|---|---|---|---|---|---|
| and | | | | | | |
| Conditional | Embodiment | Embodiment | Embodiment | Embodiment | Embodiment | Embodiment |
| Expressions | 1 | 2 | 3 | 4 | 5 | 6 |
| fA*BF/IH | 8.90 | 11.26 | 12.83 | 6.26 | 9.19 | 9.95 |
| Lp/TTL | 0.48 | 0.44 | 0.40 | 0.50 | 0.46 | 0.42 |
| Rp1/Rp2 | −3.25 | −4.00 | −2.50 | −1.90 | −3.00 | −0.80 |
| (R9 + R10)/ | −0.60 | −0.40 | −0.80 | −0.45 | −0.30 | −0.60 |
| (R9 − R10) | | | | | | |
| (f4 − f5)/f2 | 4.26 | 3.90 | 3.46 | 4.34 | 3.97 | 3.11 |
| fA | 14.500 | 14.376 | 14.267 | 14.376 | 14.376 | 14.383 |
| fp1 | 10.874 | 10.394 | 9.970 | 10.842 | 10.548 | 12.139 |
| f1 | −8.354 | −8.632 | −8.417 | −8.460 | −9.184 | −7.885 |
| f2 | 7.290 | 8.213 | 7.112 | 7.782 | 7.960 | 6.818 |
| f3 | −9.347 | −11.130 | −9.309 | −14.308 | −8.861 | −17.001 |
| f4 | 13.690 | 14.276 | 11.572 | 19.626 | 13.322 | 11.889 |
| f5 | −17.400 | −17.722 | −13.014 | −14.109 | −18.256 | −9.326 |
| Fno | 1.98 | 1.98 | 1.97 | 1.98 | 1.98 | 1.98 |
| TTL | 23.152 | 22.656 | 21.948 | 22.567 | 22.510 | 21.048 |
| IH | 3.594 | 3.594 | 3.594 | 3.594 | 3.594 | 3.594 |
| FOV | 27.33° | 27.67° | 27.87° | 27.55° | 27.56° | 27.55° |

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A camera optical lens comprising, in an order from an object side to an image side in sequence: a first prism with a positive refractive power, a first lens with a negative refractive power, a second lens with a positive refractive power, a third lens with a negative refractive power, a fourth lens with a positive refractive power, a fifth lens with a negative refractive power; wherein a reflective surface is disposed between the object side surface and image side surface of the first prism, the first lens, the second lens, the third lens, the fourth lens, and the fifth lens form a lens assembly, the lens assembly is adjustably movable along the optical axis of the camera optical lens to switch between a first state and a second state, the camera optical lens achieves its maximum focal length in the first state, and achieves its minimum focal length in the second state, the camera optical lens further satisfies the following conditions:
$$\begin{matrix}6. \leq fA * BF / IH \leq 13. ; \\ 0.4 \leq Lp / TTL \leq 0.51 ; \\ - 4.01 \leq Rp 1 / Rp 2 \leq - 0.8 ; \\ - 0.8 \leq ( R 9 + R 10 ) / ( R 9 - R 10 ) \leq - 0.3 ;\end{matrix}$$
where
fA: the focal length of the camera optical lens in the first state;
BF: the back focal length of the camera optical lens;
IH: the image height of the camera optical lens;
Lp: the distance on-axis from the most object-side lens surface to the most image-side lens surface in the first state;
Rp1: the curvature radius of the object side surface of the first prism;
Rp2: the curvature radius of the image side surface of the first prism;
s R9: the curvature radius of the object side surface of the fifth lens;
R10: the curvature radius of the image side surface of the fifth lens;
TTL: the total optical length of the camera optical lens.

2. The camera optical lens as described in claim 1 further satisfies the following condition:
$$3. \leq ( f 4 - f 5 ) / f 2 \leq 4.5 ;$$
where
f2: the focal length of the second lens;
f4: the focal length of the fourth lens;
f5: the focal length of the fifth lens.

3. The camera optical lens as described in claim 1, wherein an object side surface of the first prism is convex in the paraxial region, an image side surface of the first prism is convex in the paraxial region, and the camera optical lens further satisfies the following conditions:
$$\begin{matrix}0.6 \leq fp 1 / fA \leq 0.85 ; \\ 0.375 \leq dp 1 / TTL \leq 0.414 ;\end{matrix}$$
where
fp1: the focal length of the first prism;
dp1: the sum of the distance on-axis from the object side surface of the first prism to the reflective surface, and the distance on-axis from the reflective surface to the image side surface of the first prism.

4. The camera optical lens as described in claim 1, wherein an object side surface of the first lens is convex in the paraxial region, an image side surface of the first lens is concave in the paraxial region, and the camera optical lens further satisfies the following conditions:
$$\begin{matrix}- 0.64 \leq f 1 / fA \leq - 0.54 ; \\ 1.03 \leq ( R 1 + R 2 ) / ( r 1 - R 2 ) \leq 1.13 ; \\ 0.031 \leq d 1 / TTL\end{matrix}$$
where
f1: the focal length of the first lens;
R1: the curvature radius of the object side surface of the first lens;
R2: the curvature radius of the image side surface of the first lens;
d1: the thickness on-axis of the first lens.

5. The camera optical lens as described in claim 1, wherein an object side surface of the second lens is convex in the paraxial region, an image side surface of the second lens is convex in the paraxial region, and the camera optical lens further satisfies the following conditions:
$$\begin{matrix}0.47 \leq f 2 / fA \leq 0.58 ; \\ - 0.63 \leq ( R 3 + R 4 ) / ( R 3 - R 4 ) \leq - 0.22 ; \\ 0.063 \leq d 3 / TTL \leq 0.089 ;\end{matrix}$$
where
f2: the focal length of the second lens;
R3: the curvature radius of the object side surface of the second lens;
R4: the curvature radius of the image side surface of the second lens;
d3: the thickness on-axis of the second lens.

6. The camera optical lens as described in claim 1, wherein an object side surface of the third lens is convex in the paraxial region, an image side surface of the third lens is concave in the paraxial region, and the camera optical lens further satisfies the following conditions:
$$\begin{matrix}- 1.19 \leq f 3 / fA \leq - 0.61 ; \\ 1.6 \leq ( R 5 + R 6 ) / ( R 5 - R 6 ) \leq 2.41 ; \\ 0.066 \leq d 5 / TTL \leq 0.088 ;\end{matrix}$$
where
f3: the focal length of the third lens;
R5: the curvature radius of the object side surface of the third lens;
R6: the curvature radius of the image side surface of the third lens;
d5: the thickness on-axis of the third lens.

7. The camera optical lens as described in claim 1, wherein an object side surface of the fourth lens is concave in the paraxial region, an image side surface of the fourth lens is convex in the paraxial region, and the camera optical lens further satisfies the following conditions:
$$\begin{matrix}0.81 \leq f 4 / fA \leq 1.37 ; \\ 2.88 \leq ( R 7 + R 8 ) / ( R 7 - R 8 ) \leq 7.62 ; \\ 0.043 \leq d 7 / TTL \leq 0.048 ;\end{matrix}$$
where
f4: the focal length of the fourth lens;
R7: the curvature radius of the object side surface of the fourth lens;
R8: the curvature radius of the image side surface of the fourth lens;
d7: the thickness on-axis of the fourth lens.

8. The camera optical lens as described in claim 1, wherein an object side surface of the fifth lens is concave in the paraxial region, an image side surface of the fifth lens is concave in the paraxial region, and the camera optical lens further satisfies the following conditions:
$$\begin{matrix}- 1.28 \leq f 5 / fA \leq - 0.64 ; \\ 0.063 \leq d 9 / TTL \leq 0.073 ;\end{matrix}$$
where
f5: the focal length of the fifth lens;
d9: the thickness on-axis of the fifth lens.

9. The camera optical lens as described in claim 1, wherein the first prism is made of glass material.
